(19) United States
(12) Patent Application Publication
(10) Pub. No.: US 2011/0254454 A1
(43) Pub. Date: Oct. 20, 2011

(54) LED DRIVING DEVICE, LIGHT SOURCE DEVICE, AND LIQUID CRYSTAL DISPLAYING DEVICE

(75) Inventors: Naoto Inoue, Osaka-shi (JP); Akira Tomiyoshi, Osaka-shi (JP)

(73) Assignee: Sharp Kabushiki Kaisha 22-22, Nagaike-cho, Abeno-ku, Osaka-shi (JP)

(21) Appl. No.: 13/141,923

(22) PCT Filed: Feb. 18, 2010
(86) PCT No.: PCT/JP2010/001058

§ 371 Date: Jun. 23, 2011

(30) Foreign Application Priority Data
May 28, 2009 (JP) 2009-128541

(51) Int. Cl. H05B 37/00

(52) U.S. Cl. 315/161

(57) ABSTRACT

A first power supply voltage Vin1 of a first input section and a second power supply voltage Vin2 of the second input section satisfy an expression Vf(min)≦Vin2<Vf(typ)<Vin1≦Vf(max). A switching controller alternately electrically connects the first input section or the second input section to LEDs, and based on the difference between an average forward current detected by a detector and a target value of the average forward current, controls the ratio of a period of time for which the first input section is connected to the LEDs to a period of time for which the second input section is connected to the LEDs so that the value of the average forward current approaches the target value.

### TECHNICAL FIELD

The present invention relates to LED drive devices, light source devices, and liquid crystal display devices.

### BACKGROUND ART

In recent years, light emitting diodes (hereinafter referred to as LEDs) have been preferably used instead of conventional cold cathode fluorescent lamps, in, for example, a backlight unit which is a light source of a liquid crystal display device.

In the backlight unit which uses a plurality of LEDs as the light source, when the LEDs are connected together in series, it is necessary to provide a constant current circuit in an LED drive circuit in order to stably supply a constant current.

As the constant current circuit, for example, a regulator type constant current circuit 101 including a constant current transistor 104 as shown in FIG. 16 is known. In the regulator type constant current circuit 101, a plurality of LEDs 102 are connected together in series between the constant current transistor 104 and a single voltage input section 106. A current controller 103 is connected via an operational amplifier 105 to the output side of the constant current transistor 104. The output side of the current controller 103 is connected to the constant current transistor 104. An input voltage is supplied from the voltage input section 106 to the LEDs 102, and a current flowing through the LEDs 102 is maintained constant.

The regulator type constant current circuit 101 advantageously has a relatively simple circuit configuration. However, the constant current transistor 104 absorbs a forward voltage Vf of the LEDs 102 to generate heat, and therefore, the maximum power dissipation of the constant current transistor 104 raises a problem.

To solve this problem, switching type constant current circuits 101 in which the maximum power dissipation is substantially negligible as shown in FIGS. 17 and 18 are known.

FIG. 17 shows a circuit configuration of a conventional boost DC-DC converter type constant current circuit 101. FIG. 18 shows a circuit configuration of a conventional step-down DC-DC converter type constant current circuit 101.

In the constant current circuit 101 of FIG. 17, a coil 108 is provided between a voltage input section 106 and LEDs 102. A current controller 103 is connected via an operational amplifier 105 to the output side of the LEDs 102. The output side of the current controller 103 is connected via a PWM controller 109 and a transistor 110 to an interconnect connecting the coil 108 and the LEDs 102 together. Another terminal of the transistor 110 is grounded.

The constant current circuit 101 of FIG. 18 is different from that of FIG. 17 in a configuration on the output side of the PWM controller 109 and a configuration between the voltage input section 106 and the LEDs 102. Specifically, the PWM controller 109 has two output portions. A first output portion of the PWM controller 109 is connected to a transistor 111 interposed between interconnects connected to the voltage input section 106 and the coil 108. On the other hand, a second output portion of the PWM controller 109 is connected, via the transistor 110 one terminal of which is grounded, to the interconnect connecting the transistor 111 and the coil 108 together. One end of the capacitor 107 is connected between the coil 108 and the LED 102. With this configuration, the ground potential and the potential of the voltage input section are switched and smoothed, and then supplied to the LEDs 102.

PATENT DOCUMENT 1 describes an LED drive circuit which adjusts the luminance of an LED by controlling the width of a switching pulse output from a PMW driver, depending on any dimming voltage value, by using a circuit configuration different from those of conventional boost and buck constant current circuits.

PATENT DOCUMENT 2 describes an LED drive circuit including a PWM dimming section which adjusts the duty ratio of a PWM drive signal which is output from a PWM driver, depending on a dimming signal.

PATENT DOCUMENT 3 describes a technique of driving an LED by providing a means for changing the lengths of an on time and an off time, depending on a scanning pattern of a switch circuit.

### CITATION LIST

### Patent Documents

PATENT DOCUMENT 1: Japanese Patent Publication No. 2006-324671

PATENT DOCUMENT 2: Japanese Patent Publication No. 2006-216535

PATENT DOCUMENT 3: Japanese Patent Publication No. 2000-284753

### SUMMARY OF THE INVENTION

### Technical Problem

As is different from the regulator type constant current circuit, the conventional switching constant current circuit described above does not include a constant current transistor, and therefore, there is not the maximum power dissipation problem which is caused by heat generated by the constant current transistor. However, in the switching constant current circuit, for example, the ground potential and the potential of the voltage input section are switched, and therefore, a smoothing circuit is required in order to smooth the switching pulse and the LED current.

However, the amplitudes of the switching pulse and the LED current are relatively large, and therefore, the smoothing circuit requires a wire-wound coil having a relatively large inductance value L and a capacitor having a relatively large capacitance value C. As a result, it is difficult to reduce the size of the coil etc. in the smoothing circuit, and therefore, it is difficult to integrate the circuit itself, and it is difficult to reduce the overall size of the circuit configuration.

The present invention has been made in view of the above problems. A primary object of the present invention is to reduce the size of the circuit configuration to reduce the product cost.

### SOLUTION TO THE PROBLEM

In order to achieve the object of the present invention, a switching controller is used to alternately electrically connect a first input section or a second input section to LEDs, and control the ratio of a period of time for which the first input section is connected to the LEDs to a period of time for which the second input section is connected to the LEDs, based on the difference between an average forward current detected by a detector and a target value of the average forward current, so that the value of the average forward current approaches the target value.

Specifically, a first invention is directed to an LED drive device for driving a plurality of LEDs. The LED drive device includes a first input section configured to supply a first power supply voltage to the plurality of LEDs, a second input section configured to supply a second power supply voltage to the plurality of LEDs, a switching controller configured to switch on/off electrical connection between the first and second input sections and the plurality of LEDs, a detector configured to detect an average forward current which is an average value of an instantaneous forward current flowing through the plurality of LEDs, and a calculator configured to calculate a difference between the average forward current detected by the detector and a target value of the average forward current. The first and second power supply voltages satisfy the following expression:

Vf(min)≦Vin2<Vf(typ)<Vin1<Vf(max)

where Vin1 represents the first power supply voltage, Vin2 represents the second power supply voltage, Vf(typ) represents a typical forward voltage of the plurality of LEDs, Vf(max) represents a maximum forward voltage of the plurality of LEDs, and Vf(min) represents a minimum forward voltage of the plurality of LEDs. The switching controller alternately electrically connects the first input section or the second input section to the plurality of LEDs, and based on a result of the calculation performed by the calculator, controls a ratio of a period of time for which the first input section is electrically connected to the plurality of LEDs to a period of time for which the second input section is electrically connected to the plurality of LEDs so that the value of the average forward current approaches the target value.

A second invention is the first invention further including an LC smoothing circuit section provided between the switching controller and the plurality of LEDs and configured to smooth a current waveform formed by the switching controller.

A third invention is the first or second invention in which the detector is an AD converter.

A fourth invention is any one of the first to third inventions in which a switching section configured to switch on/off the LEDs is connected to a cathode side of the LEDs.

A fifth invention is any one of the first to third inventions that further includes an LED switching controller configured to control the switching controller so that the switching controller switches between a state in which neither the first input section nor the second input section is electrically connected to the LEDs and a state in which either the first input section or the second input section is electrically connected to the LEDs.

A sixth invention is any one of the first to fifth inventions in which there are a plurality of circuit units including the plurality of LEDs, the first input section, the second input section, the switching controller, and the calculator, and the single detector is shared by the plurality of circuit units in a time division manner.

A seventh invention is directed to a light source device including a plurality of LEDs and an LED drive device configured to drive the plurality of LEDs. The LED drive device includes a first input section configured to supply a first power supply voltage to the plurality of LEDs, a second input section configured to supply a second power supply voltage to the plurality of LEDs, a switching controller configured to switch on/off electrical connection between the first and second input sections and the plurality of LEDs, a detector configured to detect an average forward current which is an average value of an instantaneous forward current flowing through the plurality of LEDs, and a calculator configured to calculate a difference between the average forward current detected by the detector and a target value of the average forward current. The first and second power supply voltages satisfy the following expression:

Vf(min)≦Vin2<Vf(typ)<Vin1<Vf(max)

where Vin1 represents the first power supply voltage, Vin2 represents the second power supply voltage, Vf(typ) represents a typical forward voltage of the plurality of LEDs, Vf(max) represents a maximum forward voltage of the plurality of LEDs, and Vf(min) represents a minimum forward voltage of the plurality of LEDs. The switching controller alternately electrically connects the first input section or the second input section to the plurality of LEDs, and based on a result of the calculation performed by the calculator, controls a ratio of a period of time for which the first input section is electrically connected to the plurality of LEDs to a period of time for which the second input section is electrically connected to the plurality of LEDs so that the value of the average forward current approaches the target value.

An eighth invention is directed to a liquid crystal display device including a light source device and a liquid crystal display panel facing the light source device. The light source device includes a plurality of LEDs and an LED drive device configured to drive the plurality of LEDs. The LED drive device includes a first input section configured to supply a first power supply voltage to the plurality of LEDs, a second input section configured to supply a second power supply voltage to the plurality of LEDs, a switching controller configured to switch on/off electrical connection between the first and second input sections and the plurality of LEDs, a detector configured to detect an average forward current which is an average value of an instantaneous forward current flowing through the plurality of LEDs, and a calculator configured to calculate a difference between the average forward current detected by the detector and a target value of the average forward current. The first and second power supply voltages satisfy the following expression:

Vf(min)≦Vin2<Vf(typ)<Vin1≦Vf(max)

where Vin1 represents the first power supply voltage, Vin2 represents the second power supply voltage, Vf(typ) represents a typical forward voltage of the plurality of LEDs, Vf(max) represents a maximum forward voltage of the plurality of LEDs, and Vf(min) represents a minimum forward voltage of the plurality of LEDs. The switching controller alternately electrically connects the first input section or the second input section to the plurality of LEDs, and based on a result of the calculation performed by the calculator, controls a ratio of a period of time for which the first input section is electrically connected to the plurality of LEDs to a period of time for which the second input section is electrically connected to the plurality of LEDs so that the value of the average forward current approaches the target value.

### Advantages

In the first invention, the switching controller is used to switch on/off the electrical connection between the first and second input sections and the LEDs. Therefore, the first input section or the second input section is alternately electrically connected to the LEDs, whereby the first power supply voltage Vin1 from the first input section and the second power supply voltage Vin2 from the second input section are alternately supplied to the LEDs.

The detector detects an average forward current which is an average value of an instantaneous forward current flowing through the LEDs. The calculator calculates the difference between the average forward current detected by the detector and the target value of the average forward current.

Based on the result of calculation by the calculator, the switching controller controls the ratio of a period of time for which the first input section is electrically connected to the LEDs (i.e., a period of time for which the first power supply voltage Vin1 is supplied) to a period of time for which the second input section is electrically connected to the LEDs (i.e., a period of time for which the second power supply voltage Vin2 is supplied) so that the value of the average forward current approaches the target value.

For example, when the value of the average forward current is lower than the target value, the switching controller performs a switching control so that the connection time period between the first input section and the LEDs is increased while the connection time period between the second input section and the LEDs is decreased. As a result, the first power supply voltage Vin1 which is higher than the second power supply voltage Vin2 is supplied to the LEDs for a longer period of time, so that the value of the average forward current increases to approach the target value.

On the other hand, when the value of the average forward current is higher than the target value, the switching controller performs a switching control so that the connection time period between the second input section and the LEDs is increased while the connection time period between the first input section and the LEDs is decreased. As a result, the second power supply voltage Vin2 which is lower than the first power supply voltage Vin1 is supplied to the LEDs for a longer period of time, so that the value of the average forward current decreases to approach the target value.

Therefore, the average forward current flowing through the LEDs can be caused to approach the predetermined target value.

Moreover, the first power supply voltage Vin1 and the second power supply voltage Vin2 satisfy Vf(min)≦Vin2<Vf(typ)<Vin1≦Vf(max). Therefore, the amplitude of the current waveform formed by the switching controller can be reduced. As a result, when an LC smoothing circuit section is provided in order to smooth the current waveform, the size of each of the coil and capacitor of the LC smoothing circuit section can be reduced, whereby the overall size of the circuit configuration can be reduced, resulting in a reduction in product cost.

The second invention is the first invention in which an LC smoothing circuit is provided between the switching controller and the LEDs. Therefore, the current waveform formed by the switching controller is smoothed by the LC smoothing circuit. In the present invention, the amplitude of the current waveform is caused to be relatively small, and therefore, the size of each the coil and capacitor of the LC smoothing circuit can be reduced.

The third invention is the first or second invention in which the detector is an AD converter. Therefore, the average forward current of the LEDs can be detected using a more specific means.

The fourth invention is one of the first to third inventions in which a switching section is provided on the cathode side of the LEDs. Therefore, the LEDs can be switched on/off independently from the control performed by the detector, the calculator, and the switching controller.

The fifth invention is any one of the first to third inventions in which an LED switching controller for controlling the switching controller is provided. The LED switching controller controls the switching controller so that the switching controller switches between a state in which neither the first input section nor the second input section is electrically connected to the LEDs and a state in which either the first input section or the second input section is electrically connected to the LEDs. Therefore, the LEDs can be switched on/off without providing an additional switching section.

The sixth invention is any one of the first to fifth inventions in which there are a plurality of circuit units including the LEDs, the first input section, the second input section, the switching controller, and the calculator, and a single detector is shared by the circuit units in a time division manner. An increase in the overall size of the circuit can be reduced or prevented, whereby the product cost can be reduced.

The seventh invention is directed to the light source device including a plurality of LEDs and the LED drive device of the first invention. Therefore, an average forward current flowing through the LEDs can be caused to approach a predetermined target value. In addition, when an LC smoothing circuit is provided, the size of each of the coil and capacitor of the LC smoothing circuit can be reduced, whereby the overall size of the circuit configuration can be reduced, resulting in a reduction in the product cost of the light source device.

The eighth invention is directed to the liquid crystal display device including the light source device of the seventh invention and a liquid crystal display panel. Therefore, an average forward current flowing through the LEDs can be caused to approach a predetermined target value. In addition, when an LC smoothing circuit is provided, the size of each of the coil and capacitor of the LC smoothing circuit can be reduced, whereby the overall size of the circuit configuration can be reduced, resulting in a reduction in the product cost of the liquid crystal display device.

### ADVANTAGES OF THE INVENTION

According to the present invention, an average forward current flowing through LEDs can be caused to approach a predetermined target value. In addition, when a smoothing circuit is provided, the size of each of the coil and capacitor of the smoothing circuit can be reduced, whereby the overall size of the circuit configuration can be reduced, resulting in a reduction in product cost.

### BRIEF DESCRIPTION OF THE DRAWINGS

FIG. 1 is a circuit diagram showing a circuit configuration of an LED drive device according to a first embodiment.

FIG. 2 is a side view schematically showing a liquid crystal display device according to the first embodiment.

FIG. 3 is a graph showing a current waveform obtained by a step-down DC-DC LED drive device which does not include an LC smoothing circuit.

FIG. 4 is a graph showing a current waveform obtained by a step-down DC-DC LED drive device which includes a satisfactory LC smoothing circuit.

FIG. 5 is a graph showing a current waveform obtained by the LED drive device of the first embodiment which does not include an LC smoothing circuit.

FIG. 6 is a graph showing a current waveform obtained by the LED drive device of the first embodiment.

FIG. 7 is a perspective view showing an outer appearance of a so-called wire-wound coil.

FIG. 8 is a perspective view showing an outer appearance of a so-called laminated coil.

FIG. 9 is a graph showing a relationship between forward voltages Vf and forward currents (LED currents) I of the LED.

FIG. 10 is a circuit diagram showing a circuit configuration of an LED drive device according to a second embodiment.

FIG. 11 is a graph showing a current waveform in the LED drive device of the second embodiment.

FIG. 12 is a circuit diagram showing a circuit configuration of an LED drive device according to a third embodiment.

FIG. 13 is a graph showing a current waveform in the LED drive device of the third embodiment.

FIG. 14(a) is a graph showing a current waveform in a first circuit unit 20, and

FIG. 14(b) is a graph showing a current waveform in a second circuit unit 20.

FIG. 14(c) is a graph showing switching of a PWM controller 12 in the first circuit unit 20, and

FIG. 14(d) is a graph showing switching of a PWM controller 12 in the second circuit unit 20.

FIG. 14(e) is a graph showing switching of an ADC switching controller 27 in each of the first and second circuit units 20.

FIG. 15 is a circuit diagram showing a circuit configuration of an LED drive device according to a fifth embodiment.

FIG. 16 is a circuit diagram showing a conventional regulator type constant current circuit.

FIG. 17 is a diagram showing a circuit configuration of a conventional boost-up DC-DC converter type constant current circuit.

FIG. 18 is a circuit configuration showing a conventional step-down DC-DC converter type constant current circuit.

### DESCRIPTION OF EMBODIMENTS

Embodiments of the present invention will be described in detail hereinafter with reference to the accompanying drawings. Note that the present invention is not limited to the embodiments described below.

### First Embodiment of the Invention

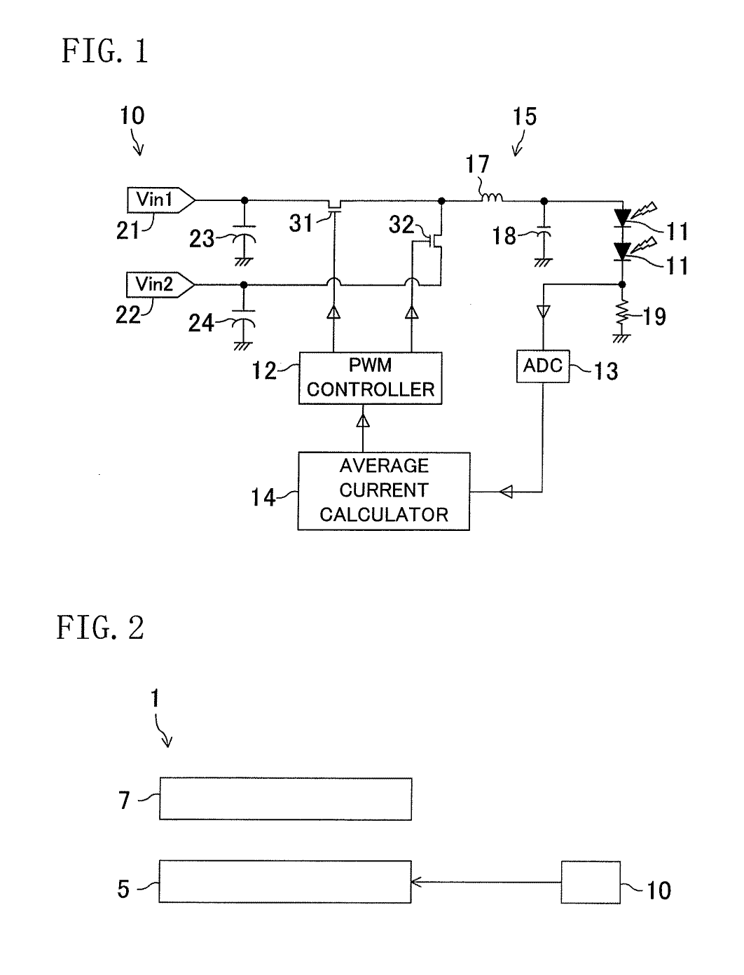

FIGS. 1-9 show a first embodiment of the present invention.

FIG. 1 is a circuit diagram showing a circuit configuration of an LED drive device according to the first embodiment. FIG. 2 is a side view schematically showing a liquid crystal display device according to the first embodiment.

### Liquid Crystal Display Device and Light Source Device

Firstly, a configuration of a liquid crystal display device 1 and a light source device 5 will be described.

As shown in FIG. 2, the liquid crystal display device 1 includes a backlight unit 5 (the light source device 5) and a liquid crystal display panel 7 facing the backlight unit 5.

Although are not shown in detail, the liquid crystal display panel 7 includes a TFT substrate as an active matrix substrate, a counter substrate facing the TFT substrate, and a liquid crystal layer provided between the TFT substrate and the counter substrate.

A plurality of pixels (not shown) are formed and arranged in a matrix in a display region (not shown) of the liquid crystal display panel 7. In each pixel, a thin-film transistor (TFT) (not shown) and a pixel electrode (not shown) connected thereto are formed. Here, a pixel is the smallest display unit.

The backlight unit 5 includes a plurality of LEDs and an LED drive circuit 10 as an LED drive device which drives the LEDs. A current of a power supply voltage is controlled and supplied to each LED, thereby causing the LED to emit light.

The liquid crystal display device 1 is configured so that light emitted by the backlight unit 5 being appropriately driven by the LED drive circuit 10 is appropriately transmitted to display a desired image.

### LED Drive Circuit

Next, the LED drive circuit 10 which drives the LEDs 11 will be described with reference to FIG. 1.

As shown in FIG. 1, the LED drive circuit 10 includes a first input section 21 and a second input section 22 as two power supply voltage input sections, a PWM controller 12 as a switching controller, an AD converter 13 as a detector, an average current calculator 14 as a calculator, and an LC smoothing circuit section 15.

The first input section 21 is used to supply a first power supply voltage Vin1 to the LEDs 11. On the other hand, the second input section 22 is used to supply a second power supply voltage Vin2 to the LEDs 11. The first and second input sections 21 and 22 are connected together in parallel and to the LEDs 11.

Here, the first power supply voltage input to the first input section 21 is represented by Vin1, the second power supply voltage input to the second input section 22 is represented by Vin2, a typical forward voltage of the LEDs 11 is represented by Vf(typ), a maximum forward voltage of the LEDs 11 is represented by Vf(max), and a minimum forward voltage of the LEDs 11 is represented by Vf(min).

In this case, the first power supply voltage Vin1 is set to be higher than the second power supply voltage Vin2. In addition, Vin1 and Vin2 are set to satisfy the following expression:

Vf(min)≦Vin2<Vf(typ)<Vin1≦Vf(max) (1)

A typical LED has current-voltage characteristics as shown in FIG. 9. FIG. 9 is a graph showing a relationship between forward voltages Vf and forward currents (LED currents) I of the LED. As shown in FIG. 9, the forward voltage Vf tends to monotonically increase with an increase in the LED current.

Here, in FIG. 9, a curve (b) indicates typical (typ) characteristics of the LED. Typically, however, the current-voltage characteristics of the LED significantly vary depending on variations in solid during manufacture, temperature characteristics, etc., even in the same product.

Typically, a value of the forward voltage Vf with respect to a target value I(set) of the LED current is defined to fall within the following range including the typical voltage value Vf(typ):

Vf(min)≦Vf(typ)≦Vf(max) (2)

In FIG. 9, a curve (a) indicates characteristics where the maximum forward voltage Vf(max) needs to be applied to the LED in order to cause the target LED current I(set) to flow through the LED. A curve (c) indicates characteristics where the minimum forward voltage Vf(min) needs to be applied to the LED to cause the target LED current I(set) to flow through the LED.

In this embodiment, the upper and lower limits of each of the first power supply voltage Vin1 and the second power supply voltage Vin2 are defined as indicated by Expression (1), and therefore, the target LED current I(set) can be caused to flow at an average current level for all LEDs whose characteristics fall between the curves (a) and (c).

As shown in FIG. 1, a first transistor 31 as a switching element is connected between interconnects connected to the first input section 21 and the LEDs 11. On other hand, a second transistor 32 is connected between interconnects connected to the second input section 22 and the LEDs 11.

One terminal of a capacitor 23 is connected to an interconnect connecting the first transistor 31 and the first input section 21 together. The other terminal of the capacitor 23 is grounded. One terminal of a capacitor 24 is connected to an interconnect connecting the second transistor 32 and the second input section 22 together. The other terminal of the capacitor 24 is grounded.

The first output terminal of the PWM controller 12 is connected to the base terminal of the first transistor 31. On the other hand, the second output terminal of the PWM controller 12 is connected to the base terminal of the second transistor 32. The PWM controller 12 switches on/off the electrical connection between the first and second input sections 21 and 22 and the LEDs 11.

A current sense resistor 19 and the input side of the AD converter 13 are connected to an interconnect connected to the cathode side of the LEDs 11. A current flowing through the current sense resistor 19 is converted into a voltage. The AD converter 13 sequentially samples this voltage to detect an average forward current (also referred to as an average current) which is an average value of an instantaneous forward current (also referred to as an LED current) flowing through the LEDs 11.

The input side of the average current calculator 14 is connected to the output side of the AD converter 13. The average current calculator 14 calculates the difference between the average forward current detected by the AD converter 13 and a target value of the average forward current. In this embodiment, the target value of the average forward current is, for example, 50 mA. The input side of the PWM controller 12 is connected to the output side of the average current calculator 14.

The PWM controller 12 alternately electrically connects the first input section 21 or the second input section 22 to the LEDs 11. The PWM controller 12 also controls the ratio of a period of time for which the first input section 21 is electrically connected to the LEDs 11 to a period of time for which the second input section 22 is electrically connected to the LEDs 11, based on the result of the calculation performed by the average current calculator 14, so that the value of the average forward current approaches the target value (50 mA) (i.e., the difference between the detected average forward current and the target value approaches zero).

For example, when the value of the average forward current obtained by the average current calculator 14 is lower than the target value (50 mA), the PWM controller 12 performs the switching control so that the connection time period between the first input section 21 and the LEDs 11 (i.e., the on time of the first transistor 31) is increased while the connection time period between the second input section 22 and the LEDs 11 (i.e., the on time of the second transistor 32) is decreased.

As a result, the first power supply voltage Vin1 which is higher than the second power supply voltage Vin2 is supplied to the LEDs 11 for a longer period of time, so that the value of the average forward current increases to approach the target value (50 mA).

On the other hand, when the value of the average forward current obtained by the average current calculator 14 is higher than the target value (50 mA), the PWM controller 12 performs the switching control so that the connection time period between the second input section 22 and the LEDs 11 (i.e., the on time of the second transistor 32) is increased while the connection time period between the first input section 21 and the LEDs 11 (i.e., the on time of the first transistor 31) is decreased.

As a result, the second power supply voltage Vin2 which is lower than the first power supply voltage Vin1 is supplied to the LEDs 11 for a longer period of time, so that the value of the average forward current decreases to approach the target value (50 mA).

Therefore, the average forward current flowing through the LEDs 11 can be caused to approach the predetermined target value (50 mA).

The LC smoothing circuit section 15 is provided between the PWM controller 12 and the LEDs 11, and smoothes a current waveform formed by the PWM controller 12. The LC smoothing circuit section 15 includes a coil 17 and a capacitor 18. One terminal of the capacitor 18 is connected to the coil while the other terminal is grounded.

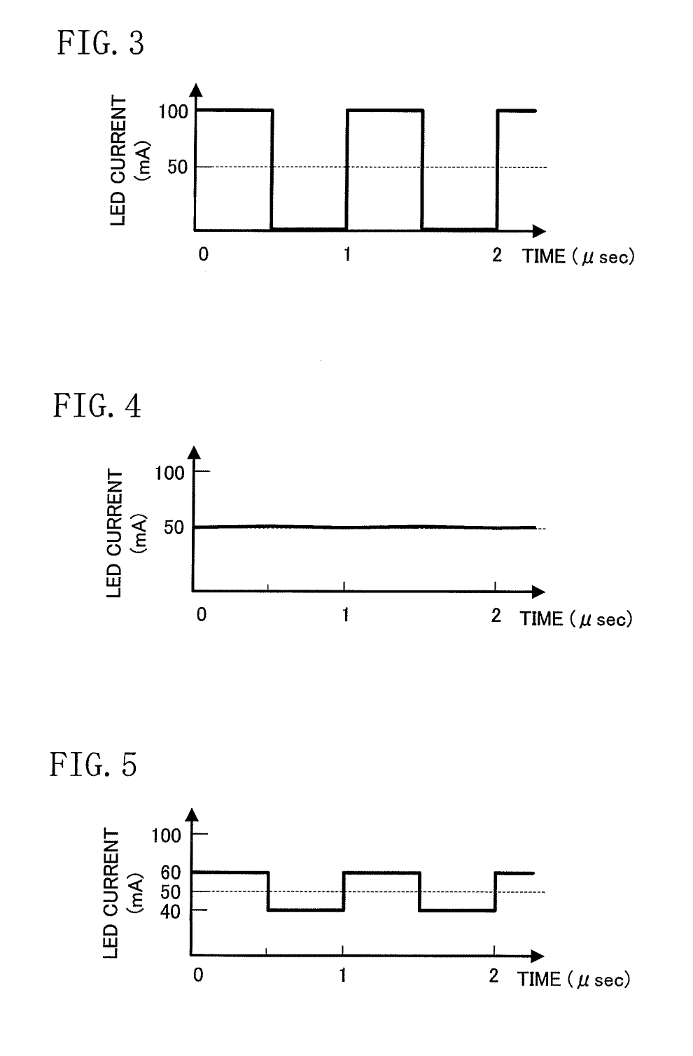

Here, FIG. 3 is a graph showing a current waveform obtained by a step-down DC-DC LED drive device which does not include an LC smoothing circuit. FIG. 4 is a graph showing a current waveform obtained by a step-down DC-DC LED drive device which includes a satisfactory LC smoothing circuit.

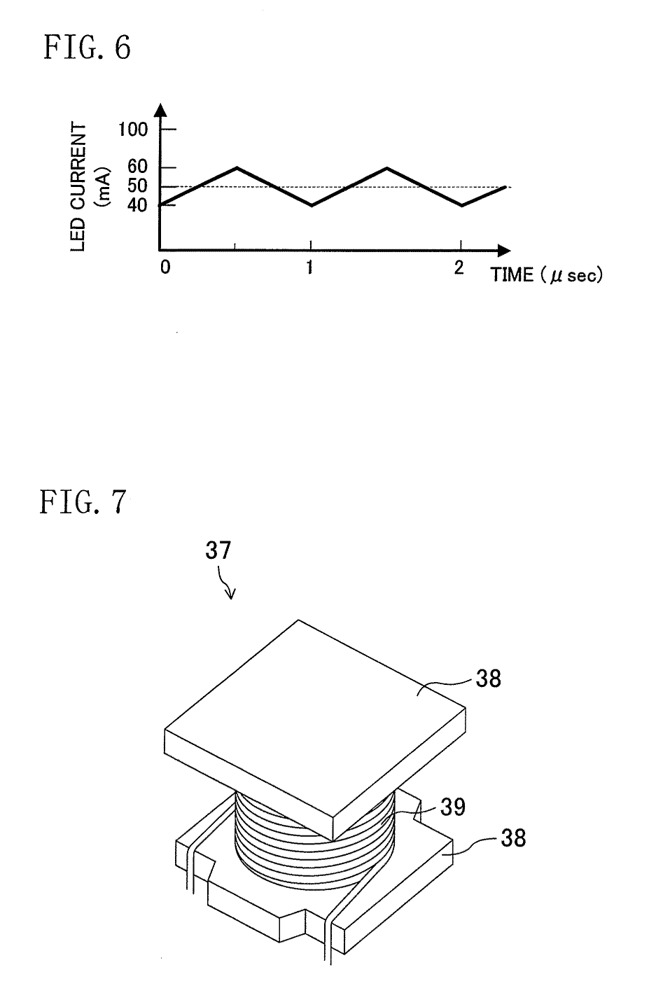

FIG. 5 is a graph showing a current waveform obtained by the LED drive device of the first embodiment which does not include an LC smoothing circuit. FIG. 6 is a graph showing a current waveform obtained by the LED drive device of the first embodiment.

A conventional step-down DC-DC LED drive device which does not include an LC smoothing circuit provides a current waveform whose amplitude is relatively large as shown in FIG. 3. In FIG. 3, the amplitude of the current waveform is 50 mA. When a satisfactory LC smoothing circuit is provided in the conventional LED drive device, then by limiting the LED current to the range of 95% to 105% of the target value, the amplitude of the current waveform is caused to be substantially zero, whereby a constant current is obtained as shown in FIG. 4. Thus, in order to obtain a constant current, the inductance value L of the coil and the capacitance value C of the capacitor in the LC smoothing circuit need to be set to be a sufficiently large value (e.g., L=10 μH or more and C=10 μF or more).

In contrast to this, in this embodiment, the first power supply voltage Vin1 and the second power supply voltage Vin2 which satisfy Expression (1) are alternately input, whereby the amplitude can be reduced to as small as 10 mA, for example, as shown in FIG. 5. Therefore, by combining the LC smoothing circuit section 15 which has relatively small L and C values with the LED drive circuit 10, a triangular current waveform whose amplitude is as small as about 10 mA can be obtained as shown in FIG. 6. In this case, by setting the frequency of the LED current of FIG. 6 to be equal to the switching frequency of the PWM controller 12 (1 MHz in FIG. 6), a flicker can be reduced or prevented.

### Advantages of First Embodiment

As described above, in this embodiment, the upper and lower limit values of each of the first power supply voltage Vin1 input to the first input section 21 and the second power supply voltage Vin2 input to the second input section 22 are defined as indicated by Expression (1). Moreover, the PWM controller 12 alternately connects the first input section 21 or the second input section 22 to the LEDs 11. In addition, the ratio of the connection time period between the first input section 21 and the LEDs 11 to the connection time period between the second input section 22 and the LEDs 11 is controlled, based on the average forward current detected by the AD converter 13 and the target value of the average forward current, so that the value of the average forward current approaches the target value.

Therefore, the amplitude of the current waveform of the current supplied to the LEDs 11 can be caused to be relatively small, and the average forward current flowing through the LEDs 11 can be caused to approach a predetermined target value. As a result, when the LC smoothing circuit section 15 is provided, the size of each of the coil and capacitor of the LC smoothing circuit section 15 can be reduced, whereby the overall size of the circuit configuration can be reduced, resulting in a reduction in product cost.

Specifically, when a coil having a large inductance value L is required as in the conventional art, a so-called wire-wound coil 37 needs to be provided in the LC smoothing circuit as shown in a coil perspective view of FIG. 7. In this case, the size of the LC smoothing circuit increases, leading to an increase in the overall size of each of the LED drive circuit 10, the backlight unit 5, and the liquid crystal display device 1. Also, because the high-cost wire-wound coil 37 is employed, the product cost of each of the devices increases.

Here, as shown in FIG. 7, the wire-wound coil 37 includes a pair of plate members 38 facing each other and a winding 39 provided between the plate members 38. The center axis of the winding 39 extends in a direction in which the plate members 38 face each other.

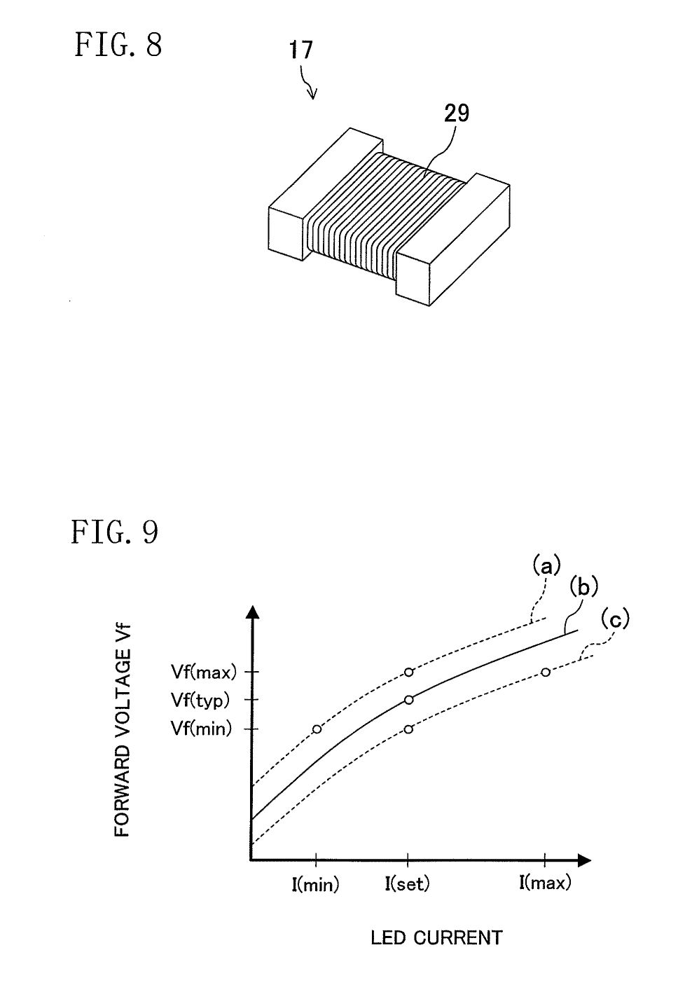

In contrast to this, in this embodiment, the LC smoothing circuit section 15 can be configured using a coil having a small inductance value L. Therefore, as shown in a perspective view of FIG. 8, as the coil, a so-called laminated coil 17, which is a relatively low-cost coil, can be provided in the LC smoothing circuit section 15. As a result, the size of the LC smoothing circuit section 15 can be decreased to reduce the parts cost, and therefore, the sizes of the LED drive circuit 10, the backlight unit 5, and the liquid crystal display device 1 can be reduced, whereby the product cost can be reduced.

Here, as shown in FIG. 7, the laminated coil 17 is formed of a large number of ceramic layers 29 which are stacked, resulting in a relatively small overall size.

### Second Embodiment of the Invention

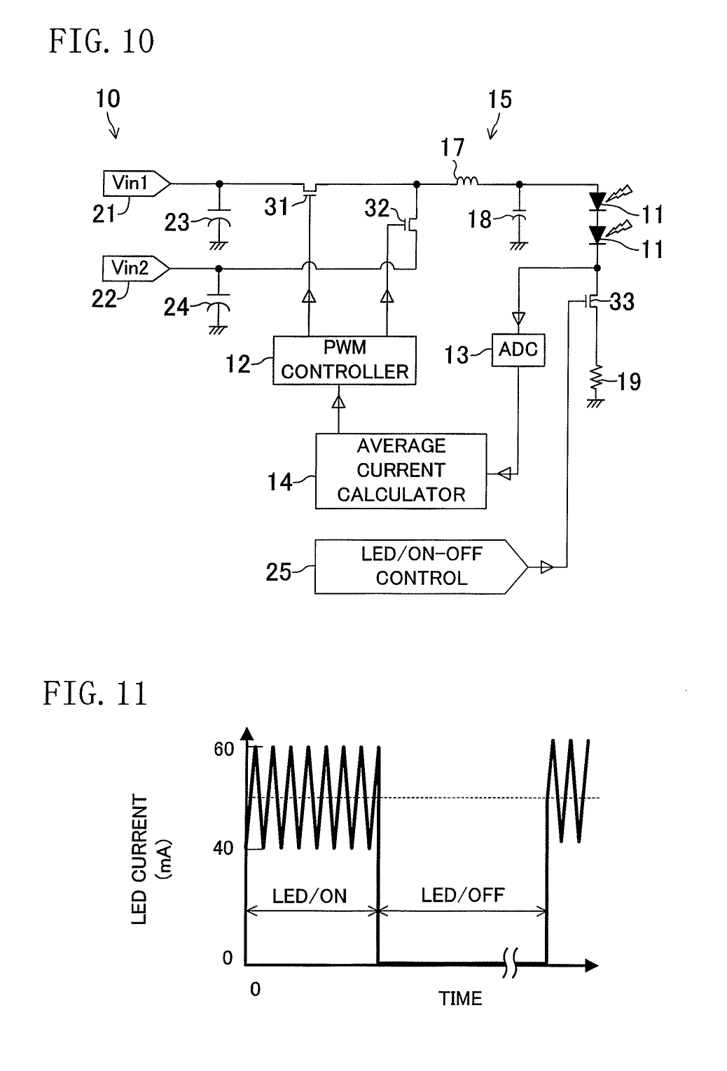

FIGS. 10 and 11 show a second embodiment according to the present invention.

FIG. 10 is a circuit diagram showing a circuit configuration of an LED drive device according to the second embodiment. FIG. 11 is a graph showing a current waveform in the LED drive device of the second embodiment. Note that, in this and the following embodiments, the same parts as those of FIGS. 1-9 are indicated by the same reference characters, and will not be described in detail.

The second embodiment is similar to the first embodiment, except that a switching section 33 for switching on/off the LEDs 11 is connected to the cathode side of the LEDs 11. As shown in FIG. 10, the switching section 33 includes a third transistor 33. An interconnect connected to the cathode side of the LEDs 11 is interposed between the switching section 33 and the LEDs 11.

As shown in FIG. 10, an LED switching controller 25 for switching on/off the third transistor 33 is connected to the base terminal of the third transistor 33. Specifically, the LED switching controller 25 switches on/off the third transistor 33 to switch on/off the supply of a current to the LEDs 11 as shown in FIG. 11, thereby switching on/off the LEDs 11.

### Advantages of Second Embodiment

Therefore, according to the second embodiment, not only advantages similar to those of the first embodiment are obtained, but also the LEDs 11 can be switched on/off independently from the current control performed by the average current calculator 14 and the PWM controller 12. Moreover, a PWM dimming control of the LEDs 11 can be performed.

### Third Embodiment of the Invention

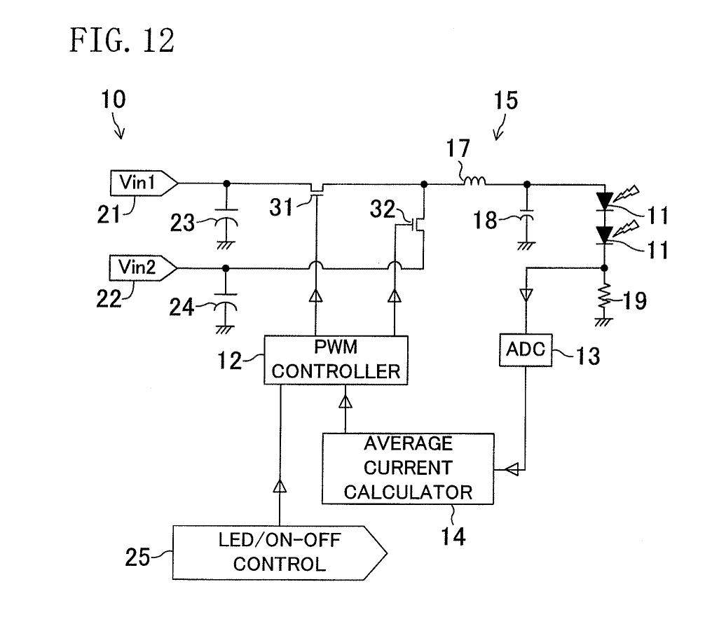

FIG. 12 shows a third embodiment of the present invention.

FIG. 12 is a circuit diagram showing a circuit configuration of an LED drive device according to the third embodiment.

The third embodiment is similar to the first embodiment, except that the LED switching controller 25 for switching on/off the LEDs 11 is connected to the PWM controller 12.

The LED switching controller 25 controls the PWM controller 12 so that the PWM controller 12 switches between a first state in which neither the first input section 21 nor the second input section 22 is electrically connected to the LEDs 11 and a second state in which either the first input section 21 or the second input section 22 is electrically connected to the LEDs 11.

Specifically, as is different from the second embodiment in which the third transistor 33 is added as a switching section, in the third embodiment the control of the PWM controller 12 is interrupted by the control of the LED switching controller 25 to switch on/off the LEDs 11.

The LED switching controller 25 causes the PWM controller 12 to switch off both the first transistor 31 and the second transistor 32, thereby switching off the LEDs 11 (first state). On the other hand, the LED switching controller 25 causes the PWM controller 12 to switch on the first transistor 31 or the second transistor 32, thereby switching on the LEDs 11 (second state).

### Advantages of Third Embodiment

Therefore, according to the third embodiment, not only advantages similar to those of the first embodiment are obtained, but also an additional switching section (the third transistor 33) is not required to switch on/off the LEDs 11. Moreover, a PWM dimming control of the LEDs 11 can be performed.

### Fourth Embodiment of the Invention

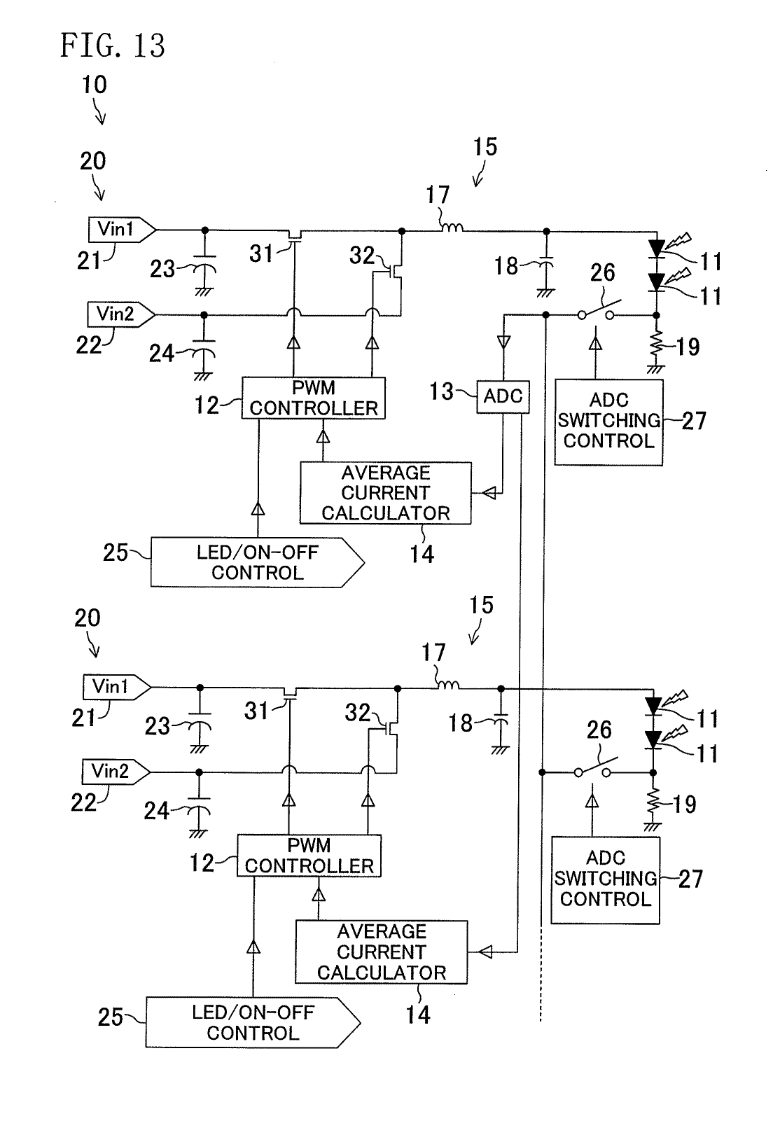

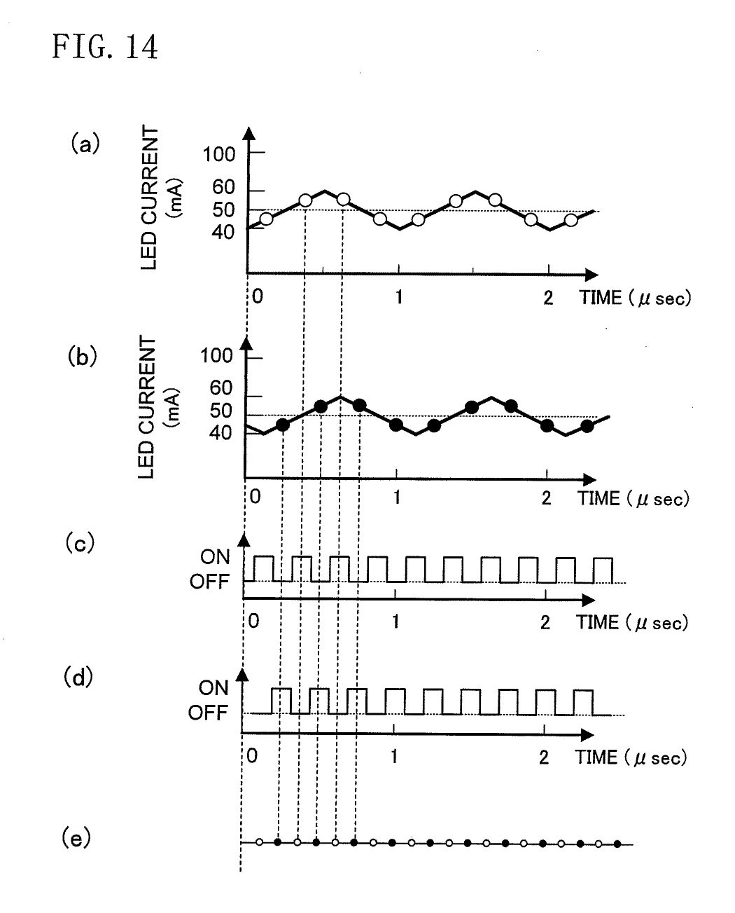

FIGS. 13 and 14 show a fourth embodiment according to the present invention.

FIG. 13 is a circuit diagram showing a circuit configuration of an LED drive device according to the fourth embodiment. FIG. 14 is a graph showing a current waveform in the LED drive device of the fourth embodiment.

Although, in the above embodiments, the LED drive circuit 10 includes a single circuit unit 20, the present invention is not limited to this. Alternatively, the LED drive circuit 10 may include a plurality of circuit units 20.

Each circuit unit 20 includes a plurality of LEDs 11, a first input section 21, a second input section 22, a PWM controller 12, and an average current calculator 14. In the fourth embodiment, each circuit unit 20 further includes an LED switching controller 25. The LED switching controller 25 is, for example, connected to the PWM controller 12 as in the third embodiment.

A single AD converter 13 is shared by the circuit units 20 in a time division manner.

Specifically, the input side of the AD converter 13 is divided into branches each of which is connected to the cathode side of the LEDs 11 in the corresponding circuit unit 20. Moreover, fourth transistors 26 as switching sections are interposed between the AD converter 13 and the LEDs 11 of the respective corresponding circuit units 20. ADC switching controllers 27 are connected to the base terminal of the respective corresponding fourth transistors 26. The ADC switching controllers 27 are provided in the respective corresponding circuit units 20. The ADC switching controllers 27 switch on/off the fourth transistors 26 in the respective corresponding circuit units 20, to determine in which circuit unit 20 the AD converter 13 should be connected to the LEDs 11.

Here, a current control in a case where the LED drive circuit 10 includes two circuit units 20 will be described with reference to the graph of FIG. 14.

FIG. 14(a) is a graph showing a current waveform in a first circuit unit 20, and FIG. 14(b) is a graph showing a current waveform in a second circuit unit 20. FIG. 14(c) is a graph showing switching of the PWM controller 12 in the first circuit unit 20, and FIG. 14(d) is a graph showing switching of the PWM controller 12 in the second circuit unit 20. FIG. 14(e) is a graph showing switching of the ADC switching controller 27 in each of the first and second circuit units 20.

As shown in FIGS. 14(a)-14(d), the PWM controller 12 switches on/off the first transistor 31 and the second transistor 32 so that the phases of current waveforms in the first and second circuit units 20 are shifted from each other. The current waveforms have the same amplitude and frequency.

As shown in FIG. 14(e), the ADC switching controllers 27 sequentially switch on/off the respective corresponding fourth transistors 26 so that the current waveforms can be measured at the same point by the common AD converter 13 in a time division manner.

Although a case where two circuit units 20 are provided has been described above, a plurality of LED currents can be similarly measured by the single AD converter 13 even when two or more circuit units 20 are provided.

### Advantages of Fourth Embodiment

Therefore, according to the fourth embodiment, not only advantages similar to those of the third embodiment are obtained, but also the single AD converter 13 can be shared by the circuit units 20, whereby the overall cost of the LED drive circuit 10 can be significantly reduced.

### Fifth Embodiment of the Invention

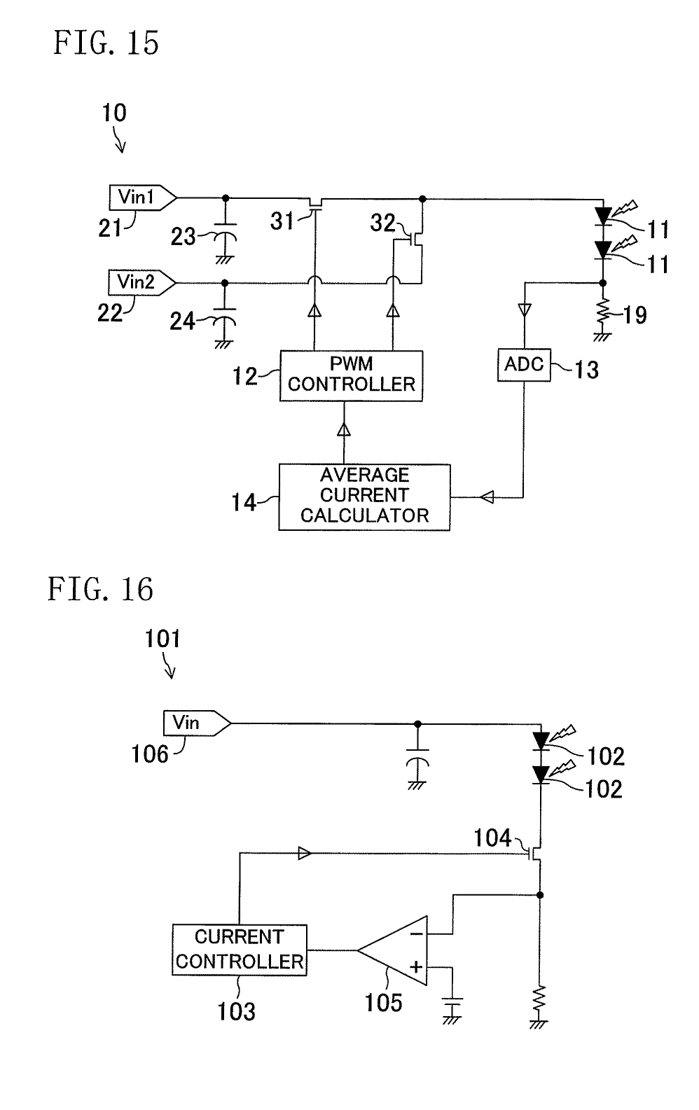

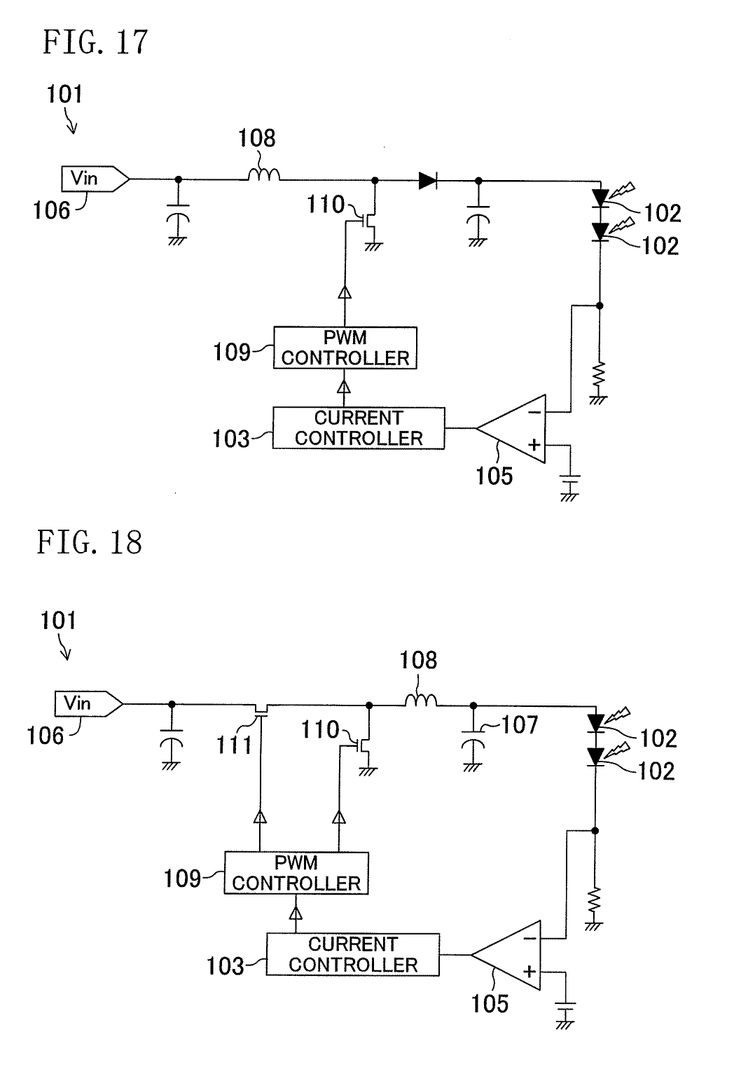

FIG. 15 shows a fifth embodiment of the present invention.

FIG. 15 is a circuit diagram showing a circuit configuration of an LED drive device of the fifth embodiment.

In the first embodiment, the LC smoothing circuit section 15 is provided in the LED drive circuit 10. Alternatively, in the fifth embodiment, as shown in FIG. 15, the LC smoothing circuit section 15 is not provided. Specifically, the first and second transistors 31 and 32 are directly connected to the LEDs 11.

### Advantages of Fifth Embodiment

In the above embodiments in which the LC smoothing circuit section 15 is provided, the current waveform of the LED current can be smoothed. However, as described above, the amplitude of the current waveform can be reduced before smoothing, and therefore, the LC smoothing circuit section 15 can be removed.

Therefore, the removal of the LC smoothing circuit section 15 can lead to a reduction in the overall size of the device and the product cost.

### Other Embodiments

While, in the fifth embodiment, a variation of the first embodiment in which the LC smoothing circuit section 15 is not provided has been described, the present invention is not limited to this. In the second to fourth embodiments, the LC smoothing circuit section 15 may not be provided.

In the above embodiments, the AD converter 13 is used to configure the detector. Alternatively, the detector may be configured by other elements. Also, in the above embodiments, the average current calculator 14 is used to configure the calculator, and the PWM controller 12 is used to configure the switching controller. The calculator and the switching controller may be configured by other elements.

In the above embodiments, the backlight unit 5 in the liquid crystal display device 1 has been described. The present invention is not limited to this, and is similarly applicable to other light source devices including the LED drive circuit 10.

### INDUSTRIAL APPLICABILITY

As described above, the present invention is useful for LED drive devices, light source devices, and liquid crystal display devices.

### DESCRIPTION OF REFERENCE CHARACTERS

1 LIQUID CRYSTAL DISPLAY DEVICE

5 BACKLIGHT UNIT (LIGHT SOURCE DEVICE)

7 LIQUID CRYSTAL DISPLAY PANEL

10 LED DRIVE CIRCUIT (LED DRIVE DEVICE)

11 LED

12 PWM CONTROLLER (SWITCHING CONTROLLER)

13 AD CONVERTER (DETECTOR)

14 AVERAGE CURRENT CALCULATOR (CALCULATOR)

15 LC SMOOTHING CIRCUIT SECTION

17 COIL

18 CAPACITOR

20 CIRCUIT UNIT

21 FIRST INPUT SECTION

22 SECOND INPUT SECTION

25 LED SWITCHING CONTROLLER

33 THIRD TRANSISTOR (SWITCHING SECTION)

1. An LED drive device for driving a plurality of LEDs, comprising:
a first input section configured to supply a first power supply voltage to the plurality of LEDs;
a second input section configured to supply a second power supply voltage to the plurality of LEDs;
a switching controller configured to switch on/off electrical connection between the first and second input sections and the plurality of LEDs;
a detector configured to detect an average forward current which is an average value of an instantaneous forward current flowing through the plurality of LEDs; and
a calculator configured to calculate a difference between the average forward current detected by the detector and a target value of the average forward current,
wherein
the first and second power supply voltages satisfy the following expression:
Vf(min)≦Vin2<Vf(typ)<Vin1≦Vf(max)
where Vin1 represents the first power supply voltage, Vin2 represents the second power supply voltage, Vf(typ) represents a typical forward voltage of the plurality of LEDs, Vf(max) represents a maximum forward voltage of the plurality of LEDs, and Vf(min) represents a minimum forward voltage of the plurality of LEDs, and
the switching controller alternately electrically connects the first input section or the second input section to the plurality of LEDs, and based on a result of the calculation performed by the calculator, controls a ratio of a period of time for which the first input section is electrically connected to the plurality of LEDs to a period of time for which the second input section is electrically connected to the plurality of LEDs so that the value of the average forward current approaches the target value.

2. The LED drive device of claim 1, further comprising:
an LC smoothing circuit section provided between the switching controller and the plurality of LEDs and configured to smooth a current waveform formed by the switching controller.

3. The LED drive device of claim 1, wherein the detector is an AD converter.

4. The LED drive device of claim 1, wherein a switching section configured to switch on/off the LEDs is connected to a cathode side of the LEDs.

5. The LED drive device of claim 1 any one of claims 1, further comprising:
an LED switching controller configured to control the switching controller so that the switching controller switches between a state in which neither the first input section nor the second input section is electrically connected to the LEDs and a state in which either the first input section or the second input section is electrically connected to the LEDs.

6. The LED drive device of claim 1, wherein
there are a plurality of circuit units including the plurality of LEDs, the first input section, the second input section, the switching controller, and the calculator, and
the single detector is shared by the plurality of circuit units in a time division manner.

7. A light source device comprising a plurality of LEDs and an LED drive device configured to drive the plurality of LEDs, wherein
the LED drive device includes a first input section configured to supply a first power supply voltage to the plurality of LEDs, a second input section configured to supply a second power supply voltage to the plurality of LEDs, a switching controller configured to switch on/off electrical connection between the first and second input sections and the plurality of LEDs, a detector configured to detect an average forward current which is an average value of an instantaneous forward current flowing through the plurality of LEDs, and a calculator configured to calculate a difference between the average forward current detected by the detector and a target value of the average forward current,
the first and second power supply voltages satisfy the following expression:
Vf(min)≦Vin2<Vf(typ)<Vin1≦Vf(max)
where Vin1 represents the first power supply voltage, Vin2 represents the second power supply voltage, Vf(typ) represents a typical forward voltage of the plurality of LEDs, Vf(max) represents a maximum forward voltage of the plurality of LEDs, and Vf(min) represents a minimum forward voltage of the plurality of LEDs, and
the switching controller alternately electrically connects the first input section or the second input section to the plurality of LEDs, and based on a result of the calculation performed by the calculator, controls a ratio of a period of time for which the first input section is electrically connected to the plurality of LEDs to a period of time for which the second input section is electrically connected to the plurality of LEDs so that the value of the average forward current approaches the target value.

8. A liquid crystal display device comprising a light source device and a liquid crystal display panel facing the light source device, wherein
the light source device includes a plurality of LEDs and an LED drive device configured to drive the plurality of LEDs,
the LED drive device includes a first input section configured to supply a first power supply voltage to the plurality of LEDs, a second input section configured to supply a second power supply voltage to the plurality of LEDs, a switching controller configured to switch on/off electrical connection between the first and second input sections and the plurality of LEDs, a detector configured to detect an average forward current which is an average value of an instantaneous forward current flowing through the plurality of LEDs, and a calculator configured to calculate a difference between the average forward current detected by the detector and a target value of the average forward current,
the first and second power supply voltages satisfy the following expression:
Vf(min)≦Vin2<Vf(typ)<Vin1≦Vf(max)
where Vin1 represents the first power supply voltage, Vin2 represents the second power supply voltage, Vf(typ) represents a typical forward voltage of the plurality of LEDs, Vf(max) represents a maximum forward voltage of the plurality of LEDs, and Vf(min) represents a minimum forward voltage of the plurality of LEDs, and
the switching controller alternately electrically connects the first input section or the second input section to the plurality of LEDs, and based on a result of the calculation performed by the calculator, controls a ratio of a period of time for which the first input section is electrically connected to the plurality of LEDs to a period of time for which the second input section is electrically connected to the plurality of LEDs so that the value of the average forward current approaches the target value.
